(19) United States
(12) Patent Application Publication
(10) Pub. No.: US 2026/0206976 A1
(43) Pub. Date: Jul. 23, 2026

(54) SUPPORT CUSHIONS FOR RECUMBENT POSITION TASKS

(71) Applicant: Colt Hansen, Grants Pass, OR (US)

(72) Inventor: Colt Hansen, Grants Pass, OR (US)

(21) Appl. No.: 19/032,361

(22) Filed: Jan. 20, 2025

(51) Int. Cl. A47C 16/00; A47C 16/04; B25H 5/00

(52) U.S. Cl. CPC A47C 16/005; A47C 16/04; B25H 5/00

(57) ABSTRACT

Support cushions including a core member comprised of a foam material that supports a person from a floor. The core member includes a rear end, a front end, a bottom surface, a back surface, and a support surface. The rear end is oriented proximate to the cabinet. The front end is opposite the rear end. The bottom surface extends from the front end to the rear end and rests on the floor. The back surface extends vertically from the bottom surface at the rear end and is configured to abut a cabinet. The support surface is disposed opposite the bottom surface and extends from the back surface to the front end. The support surface is configured to support a person resting on the support surface. The back surface has a rear height selected to complement a standard toe kick height of a toe kick of the cabinet.

### BACKGROUND

The present disclosure relates generally to cushions. In particular, support cushions for recumbent position tasks are described.

A variety of tasks require working from a recumbent (lying down) position. For example, repair, maintenance, or upgrade tasks for a vehicle can entail working under the vehicle in a supine position. A variety of tasks associated with furniture can require working from a supine or lateral recumbent position under or beside furniture. Plumbing and other tasks often necessitate working from a supine, prone, or lateral recumbent position inside a cabinet.

Performing work tasks in recumbent positions presents a host of challenges. For example, working in recumbent positions is often uncomfortable, tiring, and limits one's range of motion. Hard or irregular floor surfaces can create painful pressure points. The floor can limit the range of motion of one's bottom arm when working in a lateral recumbent position by trapping the arm between the floor and the person's torso.

Working from a recumbent position inside a cabinet has unique challenges. The toe kick of a cabinet presents a sharp edge raised off the floor. A person's body unavoidably rests on the sharp edge of the toe kick when the person is in a recumbent position partially inside and outside the cabinet. One's bodyweight pressing on the sharp edge of the toe kick is painful and limits the time one can work effectively inside a cabinet.

Thus, there exists a need for solutions to facilitate working in recumbent positions more effectively and for longer durations. Examples of new and useful support cushions relevant to the needs existing in the field are discussed below.

### SUMMARY

The present disclosure is directed to support cushions including a core member comprised of a foam material that supports a person from a floor. The core member includes a rear end, a front end, a bottom surface, a back surface, and a support surface.

The rear end is oriented proximate to the cabinet. The front end is opposite the rear end. The bottom surface extends from the front end to the rear end and rests on the floor.

The back surface extends vertically from the bottom surface at the rear end and is configured to abut a cabinet. The back surface has a rear height selected to complement a standard toe kick height of a toe kick of the cabinet.

The support surface is disposed opposite the bottom surface and extends from the back surface to the front end. The support surface is configured to support a person resting on the support surface.

### BRIEF DESCRIPTION OF THE DRAWINGS

FIG. 1 is a view of a first embodiment of a support cushion supporting a person working on his back with his head and arms inside a cabinet.

FIG. 2 is a view of the support cushion shown in FIG. 1 supporting a person working on his side.

FIG. 3 is a view of the support cushion shown in FIG. 1 supporting a person working on his knees.

FIG. 4 is a perspective view of the support cushion shown in FIG. 1.

FIG. 5 is a side elevation view of the support cushion shown in FIG. 1 depicted abutting a section of a cabinet toe kick.

FIG. 6 is a section view of an outer portion of the support cushion shown in FIG. 1 depicting an outer layer of fused cells above an open cell foam core member.

FIG. 7A is an exploded view of a second embodiment of a support cushion, which includes a tubular steel frame, a platform, and wheels.

FIG. 7B is a perspective view of the support cushion shown in FIG. 7A.

FIG. 8 is a side elevation view of a third embodiment of a support cushion, which includes a pivoting headrest, depicting the headrest pivoted to a support position inside a cabinet.

FIG. 9A is a side elevation view of the support cushion shown in FIG. 8 with the headrest pivoted to a transport position abutting a core member.

FIG. 9B is a perspective view of the support cushion shown in FIG. 8 depicting the headrest pivoting between transport and support positions.

### DETAILED DESCRIPTION

The disclosed support cushions will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various support cushions are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

### Support Cushions for Recumbent Position Tasks

With reference to the figures, support cushions for recumbent position tasks will now be described. The support cushions discussed herein function to support a person working in a recumbent position, including prone, supine, and lateral recumbent positions. The support cushions have special application supporting someone working in a recumbent position partially inside a cabinet.

The reader will appreciate from the figures and description below that the presently disclosed support cushions address many of the existing challenges associated with working in a recumbent position. For example, the novel support cushions described herein make working in a recumbent position comparatively comfortable and less tiring than working without one. The novel support cushions increase the range of motion of one's arms, which makes using tools and manipulating things by hand more effective.

Beneficially, the novel support cushions described in this document reduce or eliminate pressure points and discomfort resulting from hard or irregular floor surfaces. The novel support cushions can be used in a way that avoids limiting the range of motion of one's bottom arm when working in a lateral recumbent position from being trapped between the floor and the one's torso.

The novel support cushions described herein are especially well adapted to improve working from a recumbent position inside a cabinet. The novel support cushions allow one to avoid resting his or her body on the sharp edge of a toe kick when in a recumbent position partially inside and outside the cabinet. By properly supporting the person, the novel support cushion avoids the painful effects of the sharp toe kick edge and increases the time the person can work effectively inside a cabinet.

### Contextual Details

Ancillary features relevant to the support cushions described herein will first be described to provide context and to aid the discussion of the support cushions.

### Cabinet

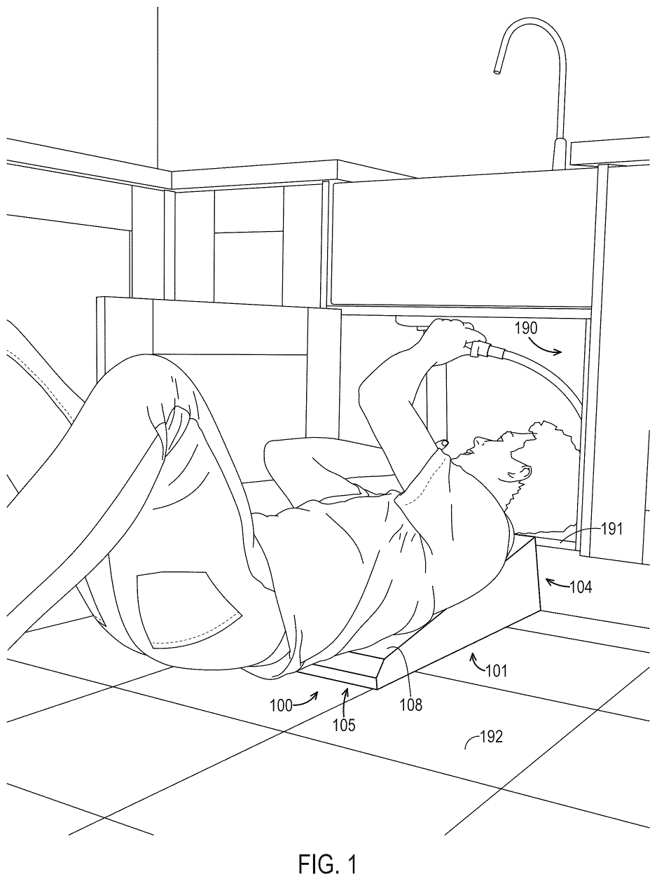

The support cushions discussed herein are specially configured to facilitate completing tasks inside cabinets from a recumbent position. Often, a person working in a cabinet will be disposed partially inside the cabinet and partially outside the cabinet. For example, as shown in FIG. 1, a person's head and upper body may be disposed inside the cabinet and the persons lower body may be disposed outside the cabinet on the floor.

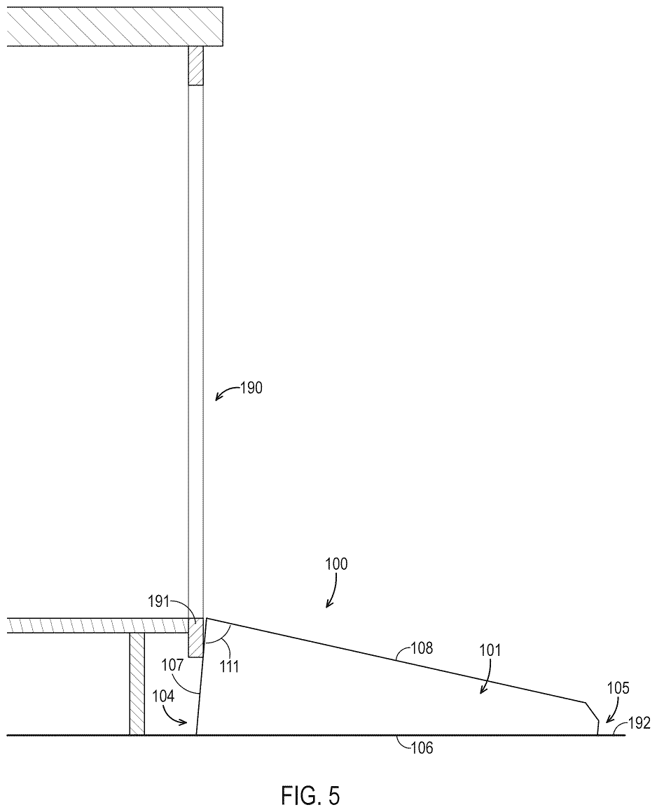

Cabinets typically include a toe kick, which is an edge proximate a bottom of the cabinet spaced above the floor. A typical cabinet 190 with a toe kick 191 spaced above a floor 192 is depicted for reference in FIGS. 1 and 5. The edge spaced above the floor levels creates an uncomfortable lip that a person's body encounters when attempting to work inside the cabinet. The novel support cushions discussed below may be complementarily configured to alleviate the painful effects of toe kicks of various heights.

In particular, as shown in the figures and described further below, the height of a rear portion of the novel support cushions may be selected to correspond to the height of the toe kick to alleviate the painful effects of the toe kick when one works on tasks partially inside the cabinet. The standard spacing off the ground of a toe kick is 6 ¾ inches, but are sometimes taller or shorter.

The novel support cushions described in this document may be used to facilitate working in a wide variety of cabinet designs with different shapes and sizes. The reader should understand that in many applications the novel support cushions facilitate working in recumbent positions when a cabinet is not involved.

### Support Cushion Embodiment One

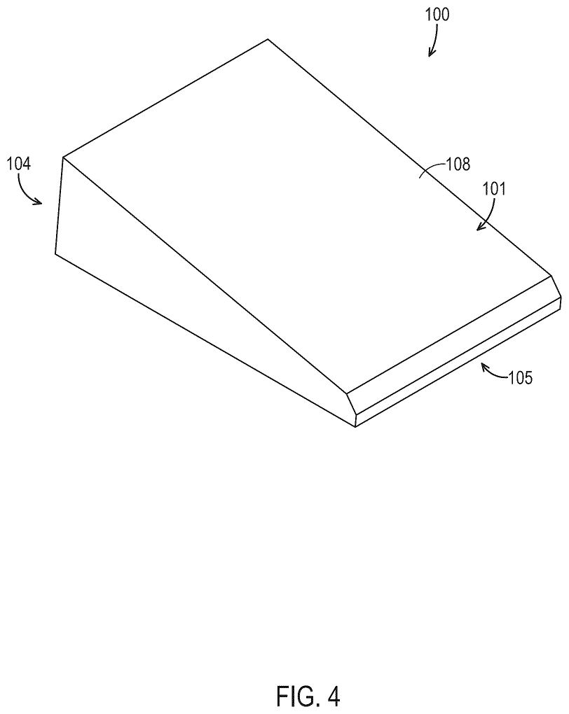

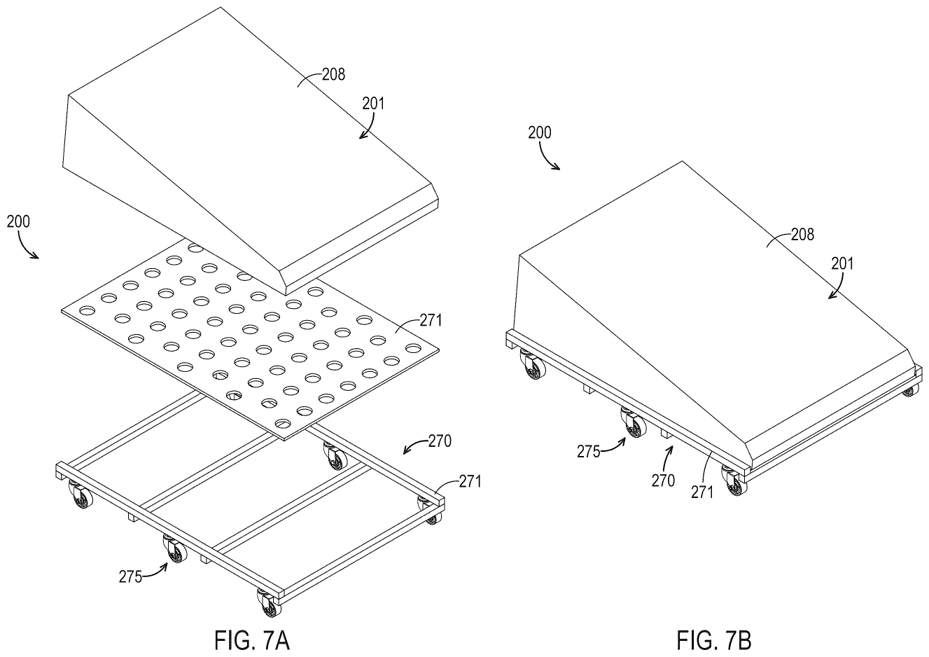

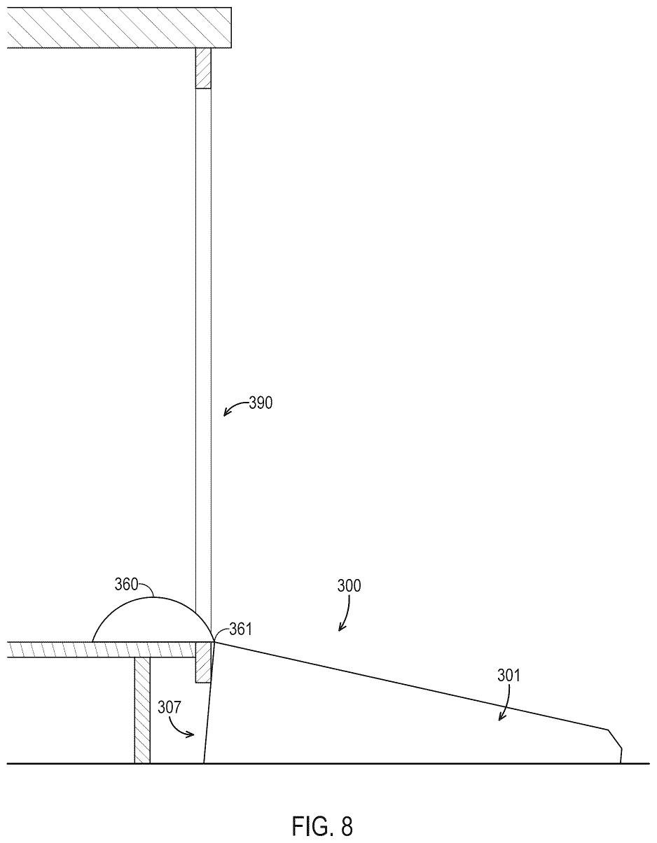

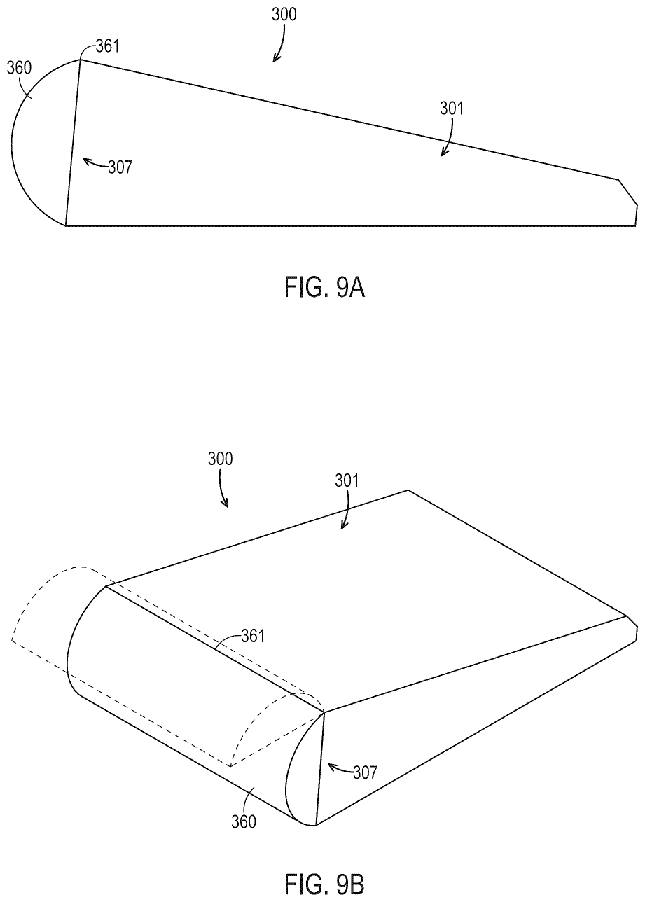

With reference to FIGS. 1-6, a first example of a support cushion, support cushion 100, will now be described. A second example of a support cushion, support cushion 200, is shown in FIGS. 7A and 7B and described in a separate section below. FIGS. 8, 9A, and 9B depict a third example of a support cushion, support cushion 300, which is also described in a separate section below.

As shown in FIGS. 1-6, support cushion 100 includes a core member 101. In other examples, the support cushion includes additional or alternative features, such as a frame, wheels, and/or a headrest. Core member 101 is discussed further below.

The size and shape of the support cushion may vary in different examples. For instance, the height of a rear portion of the support cushion may be selected to correspond with the height of given structure or member. Often the height of the rear portion is selected to avoid structures or members that interfere with working in a recumbent position, such as by causing pain or limiting one's range of motion.

### Core Member

Core member 101 functions to provide support cushion 100 with the mechanical integrity and shape necessary to support work in recumbent positions. Core member 101 is configured with a barrier layer to resist or eliminate fluids intruding into a core portion of core member 101.

As can be seen in FIG. 1-6, core member 101 includes a core substrate 102, an outer layer 103, a rear end 104, a front end 105, a bottom surface 106, a back surface 107, and a support surface 108. The components of core member 101 are described further below.

As depicted in FIGS. 1-6, core member 101 has a wedge shape. However, the shape of the core member may vary in different examples. The core member may be any shape that facilitates working in a recumbent position. The shape of the core member is often selected to facilitate working partially inside a cabinet by alleviating the pain and fatigue caused by a toe kick of a cabinet.

FIG. 5 makes apparent that core member 101 defines a pitch angle 111 between rear end 104 and front end 105. The pitch angle is selected to comfortably support a person working in a recumbent position. In the example shown in FIGS. 1-6, pitch angle 111 is selected to comfortably support a person working in a recumbent position while working inside a cabinet. More particularly, as shown in FIG. 1, pitch angle 111 is selected to comfortably support a person working in a recumbent position partially on the floor, partially on the support surface and partially on a cabinet floor inside the cabinet. Expressed another way, core member 101 defines a sloped transition providing cushioned support between floor 192 and the top of toe kick 191 of cabinet 190.

In the example shown in FIGS. 1-6, pitch angle 111 is 15 degrees resulting from a core member length of 26 inches and a core member height of 7 inches. However, the pitch angle and dimensions of the core member vary in different examples. In preferred examples, the pitch angle is between 14 and 16 degrees. In other examples, pitch angles between 12 and 18 degrees are selected.

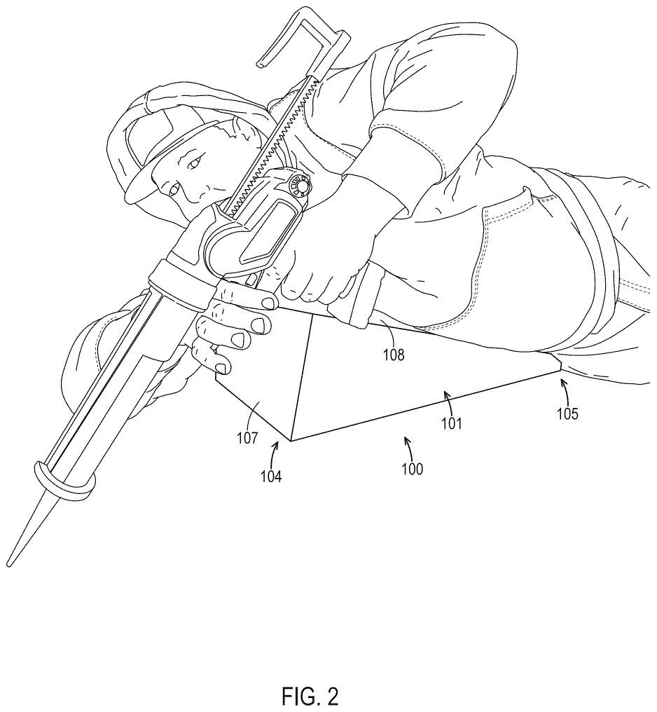

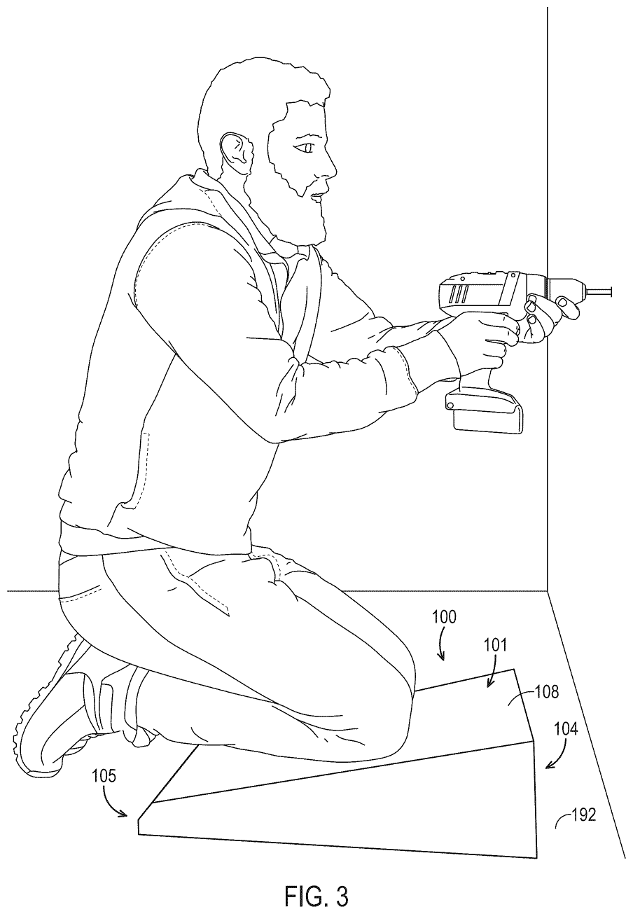

The dimensions of the core member may vary over a wide range and may be selected to suit the needs of a given application. As is apparent in FIG. 1, core member 101 has a width dimension selected to a encompass a majority of a width of a back of a person. Encompassing a majority of a user's back provides ample back support when a person works in a supine position. Such a width also enables a user to work comfortably and effectively in a lateral recumbent position as depicted in FIG. 2 and on his knees as depicted in FIG. 3.

### Core Substrate

Core substrate 102 functions to provide cushioning support for a person. In particular, core substrate supports a person from the floor, ground, or other primary support surface. Core substrate 102 also supports and defines other components of core member 101, including outer layer 103.

In the present example, core substrate 102 is comprised of a high-density, open cell foam material. However, the core substrate may be formed from any currently known or later developed material suitable for support cushion applications, including closed cell foams, various polymers, and composite materials.

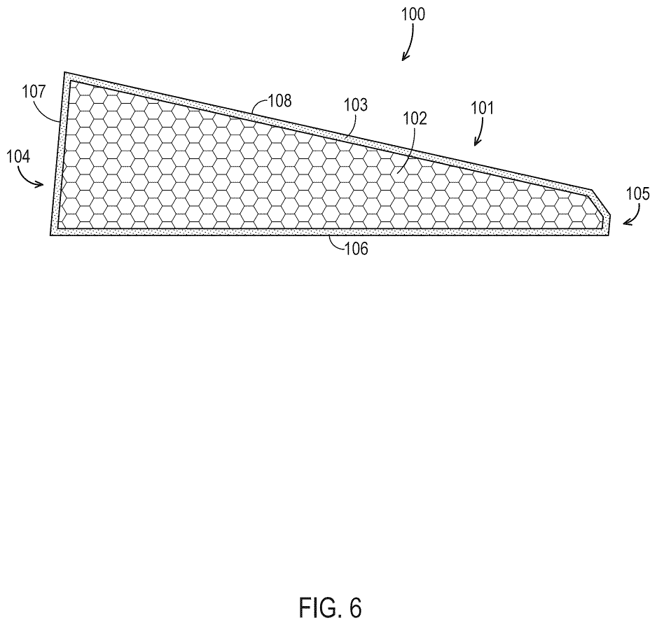

As shown in FIG. 6, core substrate 102 is surrounded by outer layer 103. Outer layer 103 is a fluid impermeable layer that protects core substrate 102 from fluid intrusion.

### Outer Layer

Outer layer 103 functions to restrict fluids from outside core member 101 intruding into core substrate 102. Outer layer 103 also serves to enhance the aesthetic appearance of core member 101 by presenting a closed cell layer that covers the open cell structure of core substrate 102.

Outer layer 103 is formed by heat treating core substrate 102. In particular, core substrate 102 in an initial liquid state is subjected to heat and compression via rollers to form a sheet. When the heated sheet is allowed to cool, outer layer 103 forms. Outer layer 103 is formed by peripheral cells of core substrate 102 fusing together from the heat exposure. The fused cells of outer layer 103 are effective to restrict fluids from passing through outer layer 103. In other examples, the outer layer is a separate material applied to the core substrate rather than a layer formed by heat treating the core substrate.

The thickness of the outer layer may be selected to meet the needs of a given application. In preferred examples, the thickness of the outer layer is effective to restrict fluids passing through the outer layer.

### Ends and Surfaces

The ends and surfaces of core member 101 define its dimensions and shape. The ends cooperate to orient support surface 108 at a desired pitch angle 111 well-suited to supporting someone working in recumbent positions. In particular, the ends and surfaces cooperate to result in a core member 101 especially well-suited to supporting one working partially inside a cabinet in a recumbent position.

With reference to FIGS. 1 and 5, front end 105 and rear end 104 are depicted in their intended orientations relative to cabinet 190. The reader can see that rear end 104 is configured to be oriented proximate to cabinet 190. Front end 105 is disposed opposite rear end 104 distal cabinet 190.

As is apparent in FIGS. 5 and 6, bottom surface 106 extends front end 105 to rear end 104. Bottom surface 106 is configured to rest on floor 192. The dimensions of the bottom surface may vary in different examples, including being larger or smaller than depicted in the figures.

The reader can see in FIGS. 5 and 6, back surface 107 extends vertically from bottom surface 106 at rear end 104. As shown in FIGS. 1 and 5, back surface 107 is configured to abut cabinet 190. In particular, back surface 107 is configured to abut toe kick 191.

Of note, back surface 107 has a rear height selected to complement a standard toe kick height of a toe kick. In the present example, the rear height of back surface is 7 inches to slightly exceed the 6 ¾ inches toe kick height of toe kick 191. In preferred examples, the rear height is between 6 and 8 inches to complement a standard toe kick height of between 6 and 8 inches.

In some examples, the rear height of the back surface is selected to exactly match the toe kick height. The rear surface being slightly shorter than the toe kick height can still provide significant relief from the edge pressure of the toe kick compared to a person resting on the floor.

As shown in FIGS. 1-6, front end 105 has a front height that is less than the rear height of back surface 107. The height of front end 105 being less than the rear height of back surface 107 results in support surface 108 having a desired pitch angle 111. In the example shown in FIG. 5, pitch angle 111 is 15 degrees resulting from bottom surface 106 having a length of 26 inches, the rear height being 7 inches, and the front height of front end being minimal. However, the pitch angle and dimensions of the core member vary in different examples. In preferred examples, the pitch angle is between 14 and 16 degrees. In other examples, pitch angles between 12 and 18 degrees are selected.

As shown in FIGS. 1-6, support surface 108 is disposed opposite bottom surface 106 distal floor 192. Support surface 108 extends from back surface 107 to front end 105.

As shown in FIGS. 1-3, support surface 108 is configured to support a person resting on it. It is apparent from the figures that support surface 108 is effective to support a person resting on it in multiple positions. Although not depicted in the figures, support surface 108 could also be used to support a person in a prone position.

As shown in FIG. 1, support surface 108 is effective to support a person in a supine position. Support surface 108 has a width selected to a encompass a majority of a width of a person's back to effectively support a person resting on support surface 108 in a supine position.

FIG. 2 demonstrates that support surface 108 is also configured to support a person in a lateral recumbent position. As shown in FIG. 2, one is able to effectively move his or her arms and use tools in a lateral recumbent position when supported on support surface 108. Pitch angle 111 of support surface 108 enables one to avoid pinning his lower arm with his torso as occurs when working from the same position while lying on the floor.

The reader can see in FIG. 3, that support surface 108 is further effective to support a person's knees in a kneeling position. The incline of support surface 108 enables one's knees and ankles to be at approximately the same height, promoting comfort and support, when a person's feet rest on floor 192 and the person's knees rest on support surface 108.

### Additional Embodiments

With reference to the figures not yet discussed, the discussion will now focus on additional support cushion embodiments. The additional embodiments include many similar or identical features to support cushion 100. Thus, for the sake of brevity, each feature of the additional embodiments below will not be redundantly explained. Rather, key distinctions between the additional embodiments and support cushion 100 will be described in detail and the reader should reference the discussion above for features substantially similar between the different support cushion examples.

### Support Cushion Embodiment Two

Turning attention to FIGS. 7A and 7B, a second example of a support cushion, support cushion 200, will now be described. As can be seen in FIGS. 7A and 7B, support cushion 200 includes a core member 201, a frame 270, a platform 272, and wheels 275. Support cushion 200 enables one using support cushion 200 to selectively translate to different positions by rolling over a floor on wheels 275 when a user is supported on support surface 208.

As shown in FIGS. 7A and 7B, frame 270 supports core member 201 from below. In the example shown in FIGS. 7A and 7B, frame 270 includes tubular members 271, but may be comprised of structural members of any shape or type. Tubular members 271 are coupled together underneath platform 272 to support platform 272 and core member 201 from below. Platform 272 is an optional feature not present in all examples.

In the present example, tubular members 271 and platform 272 are formed from metal. However, the tubular members and platform may be formed from any material for structural applications, including metals, wood, polymers, and composite materials.

As depicted in FIGS. 7A and 7B, wheels 275 are mounted to frame 270. Wheels 275 are configured to support frame 270, platform 272, and core member 201 from the floor. Wheels 275 are configured to enable support cushion 200 to selectively translate to different positions by rolling over the floor when a user is supported on support surface 208.

The wheels may be any currently known or later developed type of wheels or casters. The size, shape, and number of wheels may vary in different examples. As shown in the first and second embodiments, the wheels are an optional feature not present in all examples.

### Support Cushion Embodiment Three

Turning attention to FIGS. 8, 9A, and 9B, a third example of a support cushion, support cushion 300, will now be described. As can be seen in FIGS. 8, 9A, and 9B, support cushion 300 includes a core member 301, a headrest 360, and a pivot 361.

Headrest 360 and pivot 361 are the main distinctions between support cushion 300 and support cushion 100. Headrest 360 and pivot 361 cooperate to support a person's head and neck while in a recumbent position on support cushion 300. As shown in FIG. 8, headrest 360 and pivot 361 are well adapted to supporting a person's head and neck while working inside a cabinet.

As apparent from FIGS. 8, 9A, and 9B, headrest 360 is operatively coupled to core member 301 proximate back surface 307. In particular, headrest 360 is pivotally mounted to core member 301. As shown in FIGS. 8, 9A, and 9B, headrest 360 pivotally couples to core member 301 via pivot 361. Pivot 361 is a living hinge and integrally coupled to core member 301 and to headrest 360.

Pivot 361 is configured to pivot between a support position and a transport position. In the support position depicted in FIG. 8, headrest 360 is disposed beyond core member 301 to underlie a person's head and neck when the person rests on core member 301. As shown in FIG. 8, headrest 360 extends inside cabinet 390 when pivot 361 is in the support position.

In the transport position depicted in FIG. 9A, headrest 360 abuts back surface 307 of core member 301. The transport position makes it easier to transport support cushion 300 to different locations. The transport position also makes support cushion 300 more compact for storing it between uses.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A support cushion for use when working inside a cabinet supported on a floor, the support cushion comprising:
a core member comprised of a foam material selected to provide cushioning support between a person and the floor, the core member including:
a rear end configured to be oriented proximate to the cabinet;
a front end disposed opposite the rear end;
a bottom surface extending from the front end to the rear end and configured to rest on the floor;
a back surface extending vertically from the bottom surface at the rear end and configured to abut the cabinet; and
a support surface disposed opposite the bottom surface and extending from the back surface to the front end, the support surface configured to support a person resting on the support surface;
wherein the back surface has a rear height selected to complement a standard toe kick height of a toe kick of the cabinet.

2. The support cushion of claim 1, wherein:
the front end of the core member has a front height; and
the front height is less than the rear height.

3. The support cushion of claim 2, wherein the core member has a wedge shape.

4. The support cushion of claim 2, wherein:
the core member defines a pitch angle between the rear end and the front end; and
the pitch angle is selected to comfortably support a person resting partially on the floor, partially on the support surface, and partially on a cabinet floor inside the cabinet.

5. The support cushion of claim 4, wherein the pitch angle is between 14 and 16 degrees.

6. The support cushion of claim 1, wherein:
the core member has a width dimension; and
the width dimension is selected to a encompass a majority of a width of a back of a person.

7. The support cushion of claim 1, further comprising a headrest operatively coupled to the core member proximate the back surface.

8. The support cushion of claim 7, wherein the headrest is pivotally mounted to the core member.

9. The support cushion of claim 8, wherein the headrest is configured to selectively pivot to a support position inside the cabinet.

10. The support cushion of claim 9, wherein the headrest is further configured to selectively pivot to a transport position overlying the support surface.

11. The support cushion of claim 1, further comprising a frame coupled to the core member.

12. The support cushion of claim 11, wherein:
the support cushion further comprises wheels mounted to the frame; and
the wheels are configured to support the frame from the floor and configured to enable the support cushion to selectively translate by rolling over the floor on the wheels when a user is supported on the support surface.

13. The support cushion of claim 11, wherein the frame includes tubular members coupled together underneath the core member.

14. The support cushion of claim 1, wherein the foam material is a high-density foam.

15. The support cushion of claim 14, wherein:
the foam material is composed of open cells;
the core member defines an outer layer comprised of an outer portion of the open cells fused together; and
the outer layer is effective to restrict moisture passing through the outer layer.

16. The support cushion of claim 1, wherein the rear height is between 6 and 8 inches to complement a standard toe kick height of between 6 and 8 inches.

17. A support cushion, comprising:
a core member comprised of high-density foam and in the shape of a wedge, the core member configured to rest on a floor proximate to a cabinet supported on the floor, the core member including:
a rear end with a rear height selected to complement a standard toe kick height of the cabinet; and
a support surface extending at a downward pitch angle from the rear end towards the floor distal the cabinet, the support surface configured to support a person resting on the support surface;
wherein the core member defines a sloped transition providing cushioned support between the floor and the top of a toe kick of the cabinet.

18. The support cushion of claim 17, wherein the pitch angle is selected to comfortably support a person resting partially on the floor, partially on the support surface, and partially on a cabinet floor inside the cabinet.

19. The support cushion of claim 17, wherein the core member includes an outer layer configured to restrict moisture passing through the outer layer.

20. The support cushion of claim 19, wherein:
the high-density foam is composed of open cells; and
the core member defines an outer layer comprised of an outer portion of the open cells fused together.
